(19) United States
(12) Patent Application Publication
(10) Pub. No.: US 2016/0314048 A1
(43) Pub. Date: Oct. 27, 2016

(54) BACKUP AND RELATED OPERATIONS

(71) Applicant: BEIJING ZHIGU RUI TUO TECH CO., LTD., Beijing (CN)

(72) Inventor: Jia Liu, Beijing (CN)

(21) Appl. No.: 15/103,847

(22) PCT Filed: Nov. 6, 2014
(86) PCT No.: PCT/CN2014/090438

§ 371 Date: Jun. 10, 2016

(30) Foreign Application Priority Data
Dec. 13, 2013 (CN) 201310682957.4

(51) Int. Cl. G06F 11/14; H04W 4/00; H04W 76/04; H04W 52/02

(52) U.S. Cl. CPC G06F 11/1464; H04W 52/0209; H04W 4/008; H04W 76/045; G06F 11/1461; G06F 2201/80; G06F 2201/84

(57) ABSTRACT

Embodiments of the present application provide a backup method and an operation device. A backup method comprises: determining, in response to an editing operation of a user, operation information and an object identifier of the editing operation; and sending, based on the object identifier, the operation information to a backup device through a radio link, wherein at least one transmission parameter of the radio link is set according to a speed of the editing operation. The embodiments of the present application provide a backup operation solution, and because the at least one transmission parameter of the radio link is set according to the speed of the editing operation, backup transmission power consumption can be controlled through controlling the speed of the editing operation.

### RELATED APPLICATION

The present international patent cooperative treaty (PCT) application claims the benefit of priority to Chinese Patent Application No. 201310682957.4, filed on Dec. 13, 2013, and entitled “Backup Method and Operation Device”, which is hereby incorporated into the present international PCT application by reference herein in its entirety.

### TECHNICAL FIELD

Embodiments of the present application relate to the field of wireless technologies, and in particular, to backup and to related operations.

### BACKGROUND

Data backup usually refers to a process of copying all or a part of data from one device to another storage medium to avoid a data loss caused by a misoperation or a system fault. Conventional data backup is mainly cold backup using an in-built or external disk or tape. Currently, a common method is network backup, that is, data storage management software is used to back up data to a dedicated storage device or a remote data center in a network.

A presently underconsidered issue in data backup is backup cost, and especially for mobile devices, a presently unconsidered issue in backup cost is transmission power consumption.

### SUMMARY

An example, non-limiting objective of embodiments of the present application is to provide a backup solution in which transmission power consumption is considered.

According to one aspect of one or more embodiments of the present application, a backup method is provided, comprising:

determining, in response to an editing operation of a user, operation information and an object identifier of the editing operation; and

sending, based on the object identifier, the operation information to a backup device through a radio link, wherein at least one transmission parameter of the radio link is set according to a speed of the editing operation.

According to another aspect of one or more of the embodiments of the present application, a backup method is provided, comprising:

backing up, in response to an editing operation of a user, an object of the editing operation through a radio link, wherein at least one transmission parameter of the radio link is set according to a speed of the editing operation.

According to another aspect of one or more of the embodiments of the present application, an operation device is provided, comprising:

a determining module, configured to determine, in response to an editing operation of a user, operation information and an object identifier of the editing operation; and

a backup module, configured to send, based on the object identifier, the operation information to a backup device through a radio link, wherein at least one transmission parameter of the radio link is set according to a speed of the editing operation.

According to another aspect of one or more of the embodiments of the present application, an operation device is provided, comprising:

a backup module, configured to back up, in response to an editing operation of a user, an object of the editing operation through a radio link, wherein at least one transmission parameter of the radio link is set according to a speed of the editing operation.

At least one technical solution in the foregoing multiple technical solutions has the following non-limiting, example, beneficial effects:

One or more of the embodiments of the present application provide a backup operation solution by determining, in response to an editing operation of a user, operation information and an object identifier of the editing operation; and sending, based on the object identifier, the operation information to a backup device through a radio link, and because at least one transmission parameter of the radio link is set according to the speed of the editing operation, backup transmission power consumption can be controlled through controlling the speed of the editing operation.

### BRIEF DESCRIPTION OF THE DRAWINGS

FIG. 1 is a flowchart of a backup method according to an embodiment of the present application;

FIG. 2 is a flowchart of a backup method according to an embodiment of the present application;

FIG. 3a is a structural diagram of an operation device according to an embodiment of the present application;

FIG. 3b is a structural diagram of an embodiment shown in FIG. 3a;

FIG. 3c is a structural diagram of another embodiment shown in FIG. 3a;

FIG. 3d is a structural diagram of another embodiment shown in FIG. 3a;

FIG. 3e is a structural diagram of another embodiment shown in FIG. 3a;

FIG. 4a is a structural diagram of an operation device of another embodiment according to the present application;

FIG. 4b is a structural diagram of an embodiment shown in FIG. 4a;

FIG. 4c is a structural diagram of another embodiment shown in FIG. 4a; and

FIG. 5 is a structural diagram of an operation device according to another embodiment of the present application.

### DETAILED DESCRIPTION

The specific embodiments of the present application are further described in detail hereinafter with reference to the accompanying drawings and embodiments. The following embodiments are intended to describe the present application, but not intended to limit the scope of the present application.

A person skilled in the art may understand that, the term “backup device” in the present application should be interpreted broadly as being any device with a storage function, comprising but not limited to: a mobile phone, a personal digital assistant (PDA), a palmtop computer, a notebook computer, a desktop computer, and the like.

A person skilled in the art may understand that, the term “operation device” in the present application should be interpreted broadly as being any device that can be operated by a user, comprising but not limited to: a mobile phone, a PDA, a palmtop computer, a notebook computer, a desktop computer, and the like.

FIG. 1 is a flowchart of a first embodiment of a backup method according to the present application. As shown in FIG. 1, this embodiment comprises:

101. Determine, in response to an editing operation of a user, operation information and an object identifier of the editing operation.

For example, an operation device determines, in response to the editing operation of the user, the operation information and the object identifier of the editing operation. Alternatively, the user performs the editing operation on an object in the operation device by a user interface, such as a keyboard, a mouse, or a touch screen, provided by the operation device; and correspondingly, the operation device may determine, by its user interface, whether a user is performing an editing operation, so as to determine, in response to the editing operation of the user, operation information and an object identifier of the editing operation. The editing operation may be a single operation, for example, the user taps the keyboard once or clicks the mouse once; or may be continuous multiple operations, which is not limited in this embodiment.

The operation information is used for recording the editing operation. Alternatively, the operation information comprises an operation type and operation content. The operation type may be an editing function provided by any editing software, such as an editing function provided by the common Microsoft Word, Microsoft Excel, Microsoft Visio, or Photoshop, and the operation type comprises but not limited to at least one of the following: copy, paste, delete, enter, cut, format edit, sort, zoom in, zoom out, rotate, distort, and clip.

The object identifier of the editing operation is used for identifying an object of the editing operation, wherein the object of the editing operation may be various editable files, comprising but not limited to: a document, a picture, an audio file, a video file, and the like. Alternatively, the object identifier comprises but not limited to at least one of the following: a process identifier, a file name, and a file handle, wherein the process identifier is an identifier of a process in which the editing operation is located, and the object of the editing operation can be determined by the process identifier; the file name is a file name of the object of the editing operation, and may comprise a main file name and an extended file name, and the object of the editing operation can be determined by the file name; and the file handle is a file handle of the object of the editing operation, the object of the editing operation can be determined by the file handle. Certainly, a combination of any at least two of the process identifier, the file name, and the file handle may also be used as the object identifier, which is not limited in this embodiment.

Alternatively, the operation information further comprises: an operation position in an object corresponding to the object identifier, wherein the object corresponding to the object identifier is the object of the editing operation.

For example, when the editing operation is entering a character “A” in a word document, the operation type of the editing operation may be enter, the operation content of the editing operation may be A, the object identifier of the editing operation may be a file name of the word document, and the operation position of the editing operation in the object corresponding to the object identifier may be a position at which “A” is entered in the word document, for example, the position of a cursor when entering is started.

For another example, when the editing operation is rotating a triangle in a picture, the operation type of the editing operation may be rotate, the operation content of the editing operation may be an rotating angle, an rotating direction, and rotated content, wherein the rotated content is the triangle, the object identifier of the editing operation may be a file name of the picture, and the operation position of the editing operation in the object corresponding to the object identifier may be the position of the triangle in the picture.

102. Send, based on the object identifier, the operation information to a backup device through a radio link, wherein at least one transmission parameter of the radio link is set according to a speed of the editing operation.

The radio link may be a link based on any wireless transmission technology, and alternatively, the radio link is a wireless local area network (WLAN) link. Correspondingly, a different radio link may have at least one different transmission parameter.

The speed of the editing operation may be obtained by counting the number of single operations of the user in a time period.

In an optional embodiment, the radio link is a Bluetooth low energy link, and the at least one transmission parameter comprises: a connection interval and/or a slave latency; and correspondingly, this embodiment further comprises: in response to the speed of the editing operation decreases, increasing the connection interval and/or slave latency of the Bluetooth low energy link.

Usually, during transmission based on a Bluetooth low energy link, a data sending end is referred to as a master device, a data receiving end is referred to as a slave device, and the master device can set a connection interval and a slave latency.

The connection interval refers to a time interval between starting points of two adjacent connection events, wherein a smaller connection interval usually indicates more timely data transmission, while a larger connection interval usually indicates lower power consumption. Correspondingly, the connection interval may be set based on the speed of the editing operation, and alternatively, in response to the speed of the editing operation decreases, the connection interval of the Bluetooth low energy link may be increased, to reduce transmission power consumption. Correspondingly, in response to the speed of the editing operation increases, the connection interval of the Bluetooth low energy link may be reduced, which is not limited in this embodiment.

The slave latency refers to the maximum number of connection events that the slave device is allowed to ignore, wherein a smaller slave latency usually indicates more timely data transmission, while a larger slave latency usually indicates lower power consumption. Correspondingly, the slave latency may be set based on the speed of the editing operation, and alternatively, in response to the speed of the editing operation decreases, the slave latency of the Bluetooth low energy link may be increased, to reduce transmission power consumption. Correspondingly, in response to the speed of the editing operation increases, the slave latency of the Bluetooth low energy link may be reduced, which is not limited in this embodiment.

In another optional embodiment, the radio link is a WiFi link, and the at least one transmission parameter comprises: a contention-free period repetition interval; and correspondingly, this embodiment further comprises: in response to the speed of the editing operation decreases, increasing the contention-free period repetition interval of the WiFi link.

In WiFi point coordination function (PCF) mode, two ends of data transmission have a contention-free transmission opportunity at regular intervals. A contention-free period repetition interval refers to a time interval between two adjacent contention-free transmission opportunities, and may be set by a data sending end. A smaller contention-free period repetition interval usually indicates more timely data transmission, while a larger contention-free period repetition interval usually indicates lower power consumption. Correspondingly, in response to the speed of the editing operation increases, the contention-free period repetition interval of the WiFi link may be reduced.

Alternatively, to ensure transmission security in the radio link, the radio link may be further encrypted, for example, a link key is negotiated in a process of establishing the radio link to the backup device, a transmission key is obtained according to the link key, and in 102, the operation information is sent to the backup device after being encrypted by the transmission key.

Specifically, multiple embodiments are available for sending, based on the object identifier, the operation information to a backup device through a radio link, of which any embodiment may be used as long as the backup device can know at which object the operation information is directed.

For example, in an embodiment, the sending, based on the object identifier, the operation information to a backup device through a radio link comprises: sending the operation information and the object identifier to the backup device through the radio link.

In another embodiment, this embodiment further comprises: establishing, in the radio link, a transmission channel corresponding to the object identifier; and the sending, based on the object identifier, the operation information to a backup device through a radio link comprises: sending the operation information to the backup device through the transmission channel corresponding to the object identifier.

Alternatively, to ensure that the backup device is well prepared, before 101, this embodiment further comprises: sending a backup request to the backup device through the radio link; and if receiving a backup response of the backup device, capturing the editing operation of the user. Further, the backup request may comprise the object identifier, or the backup request may be sent to the backup device through the transmission channel corresponding to the object identifier. Usually, the backup request may be sent according to an instruction of the user, or is automatically sent when the object of the editing operation is opened.

Usually, an objective of sending operation information to a backup device is to back up the operation information, so as to implement data recovery to greatest extent when a data loss is caused by various reasons (such as a misoperation, a system fault, and power-down). In an optional scenario, after the sending, based on the object identifier, the operation information to a backup device through a radio link, this embodiment further comprises:

sending, based on the object identifier, a recovery request to the backup device through the radio link; and

receiving the operation information that is returned by the backup device through the radio link, or receiving an edited object that is returned by the backup device through the radio link, wherein the edited object is obtained by the backup device by editing, according to the operation information, the object corresponding to the object identifier.

At least one embodiment for sending, based on the object identifier, a recovery request to the backup device through the radio link may correspond to the at least one embodiment in 102 for sending, based on the object identifier, the operation information to a backup device through a radio link. For example, the operation information and the object identifier are sent to the backup device through the radio link in 102, and correspondingly, the recovery request may also be sent to the backup device together with the object identifier. For another example, the operation information is sent to the backup device through the transmission channel corresponding to the object identifier in 102, and correspondingly, the recovery request may also be sent to the backup device through the transmission channel corresponding to the object identifier. Any embodiment may be used as long as the backup device can know at which object the recovery request is directed.

Further, 101 may further comprise recording, in response to the editing operation of the user, an operation timestamp of the editing operation, and the operation information and the operation timestamp are both sent to the backup device in 102, or when receiving the operation information, the backup device uses a receiving time as an operation timestamp of the editing operation, and stores the operation timestamp in a manner of corresponding to the operation information. Correspondingly, in an optional embodiment, the recovery request carries a recovery request timestamp; and correspondingly, the backup device returns operation information whose corresponding operation timestamp is later than the recovery request timestamp, or the backup device edits the object corresponding to the object identifier in a time order according to operation information whose corresponding operation timestamp is not later than the recovery request timestamp and returns an edited object.

In another optional embodiment, the recovery request does not carry a recovery request timestamp; and correspondingly, a list of operation information corresponding to the object identifier returned by the backup device may be received, and then a piece of operation information therein may be selected according to an instruction of the user, and the backup device returns operation information whose corresponding operation timestamp is later than an operation timestamp of the selected operation information, or the backup device edits the object corresponding to the object identifier in a time order according to operation information whose corresponding operation timestamp is not later than the operation timestamp of the selected operation information and returns an edited object. The operation timestamp of the selected operation information is equivalent to the recovery request timestamp.

In another optional embodiment, the recovery request may carry a recovery request time period; and correspondingly, a list of operation information, which is returned by the backup device, whose corresponding operation timestamp is within the time period may be received, and then a piece of operation information therein may be selected according to an instruction of the user, and the backup device returns operation information whose corresponding operation timestamp is later than an operation timestamp of the selected operation information, or the backup device edits the object corresponding to the object identifier in a time order according to operation information whose corresponding operation timestamp is not later than the operation timestamp of the selected operation information and returns an edited object. The operation timestamp of the selected operation information is equivalent to the recovery request timestamp.

In the foregoing embodiments, after the operation information returned by the backup device is received, at least one corresponding editing operation may be further canceled based on the current object according to the operation information returned by the backup device, to obtain an object at the recovery request timestamp.

In the foregoing embodiments, in the scenario in which the backup device returns the edited object, the backup device usually stores an object corresponding to the object identifier of a moment before; and correspondingly, that the backup device edits the object corresponding to the object identifier in a time order according to operation information whose corresponding operation timestamp is not later than the recovery request timestamp is specifically that: in a time order according to operation information whose corresponding operation timestamp is not earlier than the moment corresponding to the object stored by the backup device and is not later than the recovery request timestamp, the backup device edits the object stored by the backup device, and that the backup device edits the object corresponding to the object identifier in a time order according to operation information whose corresponding operation timestamp is not later than the operation timestamp of the selected operation information is specifically that: in a time order according to operation information whose corresponding operation timestamp is not earlier than the moment corresponding to the object stored by the backup device and is not later than the operation timestamp of the selected operation information, the backup device edits the object stored by the backup device.

Alternatively, to save storage space in the backup device, after 102, this embodiment may further comprise: sending, based on the object identifier, a stop backup request to the backup device, wherein the stop backup request is used for instructing the backup device to delete the operation information.

Usually, the stop backup request may be sent according to an instruction of the user, or is automatically sent when the object of the editing operation is closed. Optionally, the backup device may delete the operation information immediately after receiving the stop backup request, or may not delete the operation information immediately after receiving the stop backup request but store the operation information for a time period before deletion, so that another object could use the operation information. Further, the backup device may further send the operation information to a cloud server, so that the operation information could be directly recovered from the cloud server.

It should be noted that, one operation device may have multiple backup devices, and one backup device may also serve multiple operation devices. An operation device may distinguish different backup devices according to connection related address information, such as an IP address, a physical address, or a link address, and a backup device may distinguish different operation devices by connection related address information.

This embodiment provides a backup operation solution by determining, in response to an editing operation of a user, operation information and an object identifier of the editing operation; and sending, based on the object identifier, the operation information to a backup device through a radio link, and because at least one transmission parameter of the radio link is set according to the speed of the editing operation, backup transmission power consumption can be controlled through controlling the speed of the editing operation.

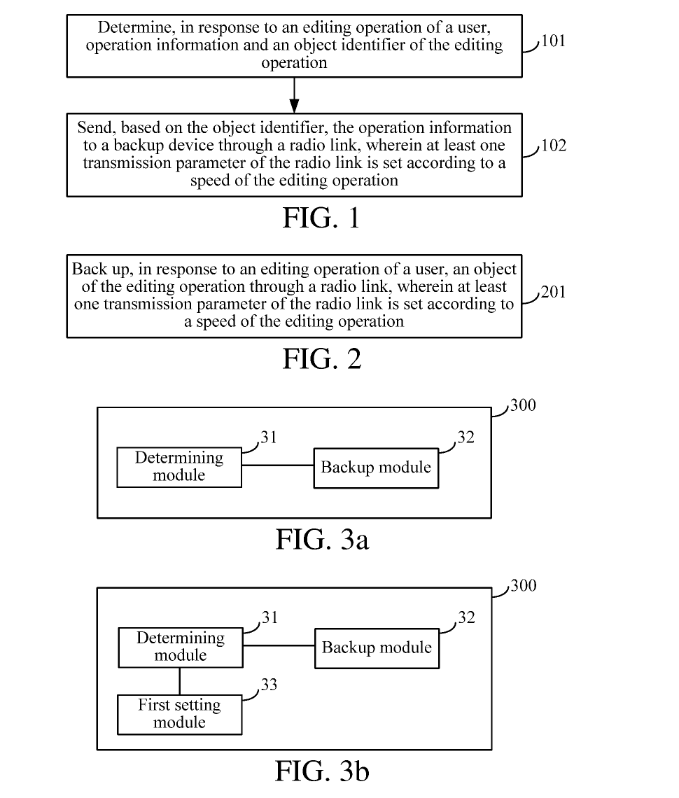

FIG. 2 is a flowchart of another embodiment of a backup method according to the present application. As shown in FIG. 2, this embodiment comprises:

201. Back up, in response to an editing operation of a user, an object of the editing operation through a radio link, wherein at least one transmission parameter of the radio link is set according to a speed of the editing operation.

For example, an operation device backs up, in response to the editing operation of the user, the object of the editing operation through the radio link. Alternatively, the user performs the editing operation on an object in the operation device by a user interface, such as a keyboard, a mouse, or a touch screen, provided by the operation device; and correspondingly, the operation device may determine, by its user interface, whether a user is performing an editing operation, so as to back up, in response to the editing operation of the user, an object of the editing operation through a radio link. The editing operation may be a single operation, for example, the user taps the keyboard once or clicks the mouse once; or may be continuous multiple operations, which is not limited in this embodiment.

The object of the editing operation may be various editable files, comprising but not limited to: a document, a picture, an audio file, a video file, and the like.

Specifically, an object obtained by editing according to the editing operation may be sent to the backup device through the radio link in 201.

The radio link may be a link based on any wireless transmission technology, and alternatively, the radio link is a WLAN link. Correspondingly, a different radio link may have at least one different transmission parameter.

The speed of the editing operation may be obtained by counting the number of single operations of the user in a time period.

In an optional embodiment, the radio link is a Bluetooth low energy link, and the at least one transmission parameter comprises: a connection interval and/or a slave latency; and correspondingly, this embodiment further comprises: in response to the speed of the editing operation decreases, increasing the connection interval and/or slave latency of the Bluetooth low energy link.

Usually, during transmission based on a Bluetooth low energy link, a data sending end is referred to as a master device, a data receiving end is referred to as a slave device, and the master device can set a connection interval and a slave latency.

The connection interval refers to a time interval between starting points of two adjacent connection events, wherein a smaller connection interval usually indicates more timely data transmission, while a larger connection interval usually indicates lower power consumption. Correspondingly, the connection interval may be set based on the speed of the editing operation, and alternatively, in response to the speed of the editing operation decreases, the connection interval of the Bluetooth low energy link may be increased, to reduce transmission power consumption. Correspondingly, in response to the speed of the editing operation increases, the connection interval of the Bluetooth low energy link may be reduced, which is not limited in this embodiment.

The slave latency refers to the maximum number of connection events that the slave device is allowed to ignore, wherein a smaller slave latency usually indicates more timely data transmission, while a larger slave latency usually indicates lower power consumption. Correspondingly, the slave latency may be set based on the speed of the editing operation, and alternatively, in response to the speed of the editing operation decreases, the slave latency of the Bluetooth low energy link may be increased, to reduce transmission power consumption. Correspondingly, in response to the speed of the editing operation increases, the slave latency of the Bluetooth low energy link may be reduced, which is not limited in this embodiment.

In another optional embodiment, the radio link is a WiFi link, and the at least one transmission parameter comprises: a contention-free period repetition interval; and correspondingly, this embodiment further comprises: in response to the speed of the editing operation decreases, increasing the contention-free period repetition interval of the WiFi link.

In WiFi PCF mode, two ends of data transmission have a contention-free transmission opportunity at regular intervals. A contention-free period repetition interval refers to a time interval between two adjacent contention-free transmission opportunities, and may be set by a data sending end. A smaller contention-free period repetition interval usually indicates more timely data transmission, while a larger contention-free period repetition interval usually indicates lower power consumption. Correspondingly, in response to the speed of the editing operation increases, the contention-free period repetition interval of the WiFi link may be reduced.

Alternatively, to ensure transmission security in the radio link, the radio link may be further encrypted, for example, a link key is negotiated in a process of establishing the radio link to the backup device, a transmission key is obtained according to the link key, and in 201, the object obtained by editing according to the editing operation is sent to the backup device after being encrypted by the transmission key.

Alternatively, to ensure that the backup device is well prepared, before 201, this embodiment further comprises: sending a backup request to the backup device through the radio link; and if receiving a backup response of the backup device, capturing the editing operation of the user. Usually, the backup request may be sent according to an instruction of the user, or is automatically sent when the object of the editing operation is opened.

Alternatively, to save storage space in the backup device, after 201, this embodiment may further comprise: sending a stop backup request to the backup device, wherein the stop backup request is used for instructing the backup device to delete a backup object.

The stop backup request may carry an object identifier of the object, and the object identifier comprises but not limited to at least one of the following: a process identifier, a file name, and a file handle, wherein the process identifier is an identifier of a process in which the editing operation is located, and the backup device can determine the object of the editing operation by the process identifier; the file name is a file name of the object of the editing operation, and may comprise a main file name and an extended file name, and the backup device can determine the object of the editing operation by the file name; and the file handle is a file handle of the object of the editing operation, the backup device can determine the object of the editing operation by the file handle. Certainly, a combination of any at least two of the process identifier, the file name, and the file handle may also be used as the object identifier, which is not limited in this embodiment.

Usually, the stop backup request may be sent according to an instruction of the user, or is automatically sent when the object of the editing operation is closed. Optionally, the backup device may delete the operation information immediately after receiving the stop backup request, or may not delete the operation information immediately after receiving the stop backup request but store the operation information for a time period before deletion, so that another object could use the operation information. Further, the backup device may further send the operation information to a cloud server, so that the operation information could be directly recovered from the cloud server.

It should be noted that, one operation device may have multiple backup devices, and one backup device may also serve multiple operation devices. An operation device may distinguish different backup devices according to connection related address information, such as an IP address, a physical address, or a link address, and a backup device may distinguish different operation devices by connection related address information.

This embodiment provides a backup object solution by backing up, in response to an editing operation of a user, an object of the editing operation through a radio link, and because at least one transmission parameter of the radio link is set according to a speed of the editing operation, backup transmission power consumption can be controlled through controlling the speed of the editing operation.

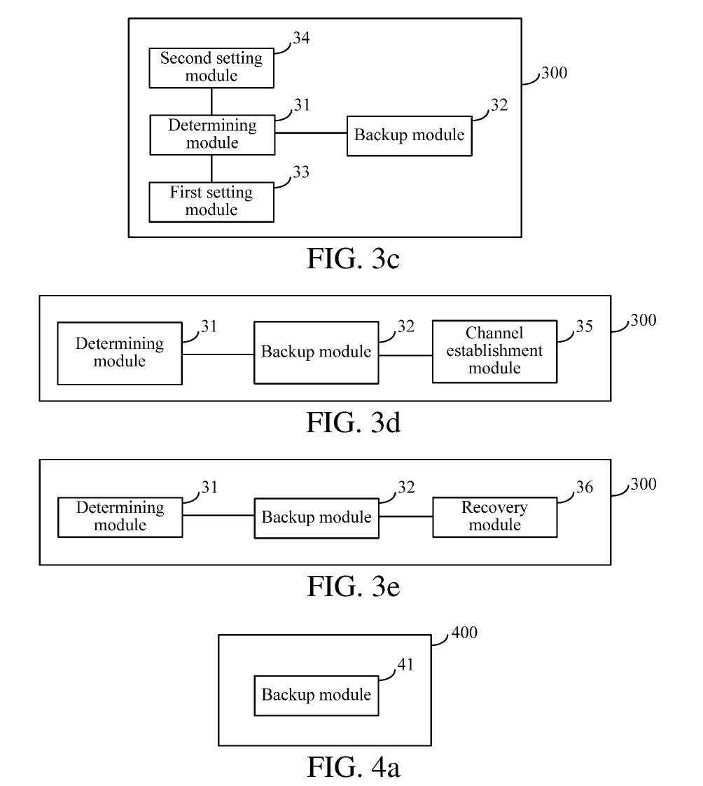

FIG. 3a is a structural diagram of an embodiment of an operation device according to the present application. As shown in FIG. 3a, an operation device 300 comprises:

a determining module 31, configured to determine, in response to an editing operation of a user, operation information and an object identifier of the editing operation; and

a backup module 32, configured to send, based on the object identifier, the operation information to a backup device through a radio link, wherein at least one transmission parameter of the radio link is set according to a speed of the editing operation.

Alternatively, the user performs the editing operation on an object in the operation device 300 by a user interface, such as a keyboard, a mouse, or a touch screen, provided by the operation device 300; and correspondingly, the determining module 31 may determine, by the user interface of the operation device 300, whether a user is performing an editing operation, so as to determine, in response to the editing operation of the user, operation information and an object identifier of the editing operation. The editing operation may be a single operation, for example, the user taps the keyboard once or clicks the mouse once; or may be continuous multiple operations, which is not limited in this embodiment.

The operation information is used for recording the editing operation. Alternatively, the operation information comprises an operation type and operation content. The operation type may be an editing function provided by any editing software, such as an editing function provided by the common Microsoft Word, Microsoft Excel, Microsoft Visio, or Photoshop, and the operation type comprises but not limited to at least one of the following: copy, paste, delete, enter, cut, format edit, sort, zoom in, zoom out, rotate, distort, and clip.

The object identifier of the editing operation is used for identifying an object of the editing operation, wherein the object of the editing operation may be various editable files, comprising but not limited to: a document, a picture, an audio file, a video file, and the like. Alternatively, the object identifier comprises but not limited to at least one of the following: a process identifier, a file name, and a file handle, wherein the process identifier is an identifier of a process in which the editing operation is located, and the object of the editing operation can be determined by the process identifier; the file name is a file name of the object of the editing operation, and may comprise a main file name and an extended file name, and the object of the editing operation can be determined by the file name; and the file handle is a file handle of the object of the editing operation, the object of the editing operation can be determined by the file handle. Certainly, a combination of any at least two of the process identifier, the file name, and the file handle may also be used as the object identifier, which is not limited in this embodiment.

Alternatively, the operation information further comprises: an operation position in an object corresponding to the object identifier, wherein the object corresponding to the object identifier is the object of the editing operation.

For example, when the editing operation is entering a character “A” in a word document, the operation type of the editing operation may be enter, the operation content of the editing operation may be A, the object identifier of the editing operation may be a file name of the word document, and the operation position of the editing operation in the object corresponding to the object identifier may be a position at which “A” is entered in the word document, for example, the position of a cursor when entering is started.

For another example, when the editing operation is rotating a triangle in a picture, the operation type of the editing operation may be rotate, the operation content of the editing operation may be an rotating angle, an rotating direction, and rotated content, wherein the rotated content is the triangle, the object identifier of the editing operation may be a file name of the picture, and the operation position of the editing operation in the object corresponding to the object identifier may be the position of the triangle in the picture.

The radio link may be a link based on any wireless transmission technology, and alternatively, the radio link is a WLAN link. Correspondingly, a different radio link may have at least one different transmission parameter.

The speed of the editing operation may be obtained by counting the number of single operations of the user in a time period.

In an optional embodiment, the radio link is a Bluetooth low energy link, and the at least one transmission parameter comprises: a connection interval and/or a slave latency; and correspondingly, as shown in FIG. 3b, the operation device 300 further comprises: a first setting module 33, configured to: in response to the speed of the editing operation decreases, increase the connection interval and/or slave latency of the Bluetooth low energy link.

Usually, during transmission based on a Bluetooth low energy link, a data sending end is referred to as a master device, a data receiving end is referred to as a slave device, and the master device can set a connection interval and a slave latency.

The connection interval refers to a time interval between starting points of two adjacent connection events, wherein a smaller connection interval usually indicates more timely data transmission, while a larger connection interval usually indicates lower power consumption. Correspondingly, the first setting module 33 may set the connection interval based on the speed of the editing operation, and alternatively, in response to the speed of the editing operation decreases, the first setting module 33 may increase the connection interval of the Bluetooth low energy link, to reduce transmission power consumption. Correspondingly, in response to the speed of the editing operation increases, the first setting module 33 may reduce the connection interval of the Bluetooth low energy link, which is not limited in this embodiment.

The slave latency refers to the maximum number of connection events that the slave device is allowed to ignore, wherein a smaller slave latency usually indicates more timely data transmission, while a larger slave latency usually indicates lower power consumption. Correspondingly, the first setting module 33 may set the slave latency based on the speed of the editing operation, and alternatively, in response to the speed of the editing operation decreases, the first setting module 33 may increase the slave latency of the Bluetooth low energy link, to reduce transmission power consumption. Correspondingly, in response to the speed of the editing operation increases, the first setting module 33 may reduce the slave latency of the Bluetooth low energy link, which is not limited in this embodiment.

In another optional embodiment, the radio link is a WiFi link, and the at least one transmission parameter comprises: a contention-free period repetition interval; and correspondingly, as shown in FIG. 3c, the operation device 300 further comprises: a second setting module 34, configured to: in response to the speed of the editing operation decreases, increase the contention-free period repetition interval of the WiFi link.

In WiFi PCF mode, two ends of data transmission have a contention-free transmission opportunity at regular intervals. A contention-free period repetition interval refers to a time interval between two adjacent contention-free transmission opportunities, and may be set by a data sending end. A smaller contention-free period repetition interval usually indicates more timely data transmission, while a larger contention-free period repetition interval usually indicates lower power consumption.

Alternatively, to ensure transmission security in the radio link, the radio link may be further encrypted, for example, a link key is negotiated in a process of establishing the radio link to the backup device, a transmission key is obtained according to the link key, and the backup module 32 may send the operation information to the backup device after encrypting the operation information by the transmission key.

Specifically, multiple embodiments are available for the backup module 32 to send, based on the object identifier, the operation information to a backup device through a radio link, of which any embodiment may be used as long as the backup device can know at which object the operation information is directed.

For example, in an embodiment, the backup module 32 is further configured to: send the operation information and the object identifier to the backup device through the radio link.

In another embodiment, as shown in FIG. 3d, the operation device 300 further comprises: a channel establishment module 35, configured to establish, in the radio link, a transmission channel corresponding to the object identifier; and the backup module 32 is further configured to: send the operation information to the backup device through the transmission channel corresponding to the object identifier.

Alternatively, to ensure that the backup device is well prepared, the backup module 32 is further configured to: send, a backup request to the backup device through the radio link; and if a backup response of the backup device is received, trigger the determining module 31 to capture the editing operation of the user. Further, the backup request may comprise the object identifier, or the backup request may be sent to the backup device through the transmission channel corresponding to the object identifier. Usually, the backup request may be sent by the backup module 32 according to an instruction of the user, or is automatically sent by the backup module 32 when the object of the editing operation is opened.

Usually, an objective of sending operation information to a backup device is to back up the operation information, so as to implement data recovery to greatest extent when a data loss is caused by various reasons (such as a misoperation, a system fault, and power-down). In an optional embodiment, as shown in FIG. 3e, the operation device 300 further comprises:

a recovery module 36, configured to send, based on the object identifier, a recovery request to the backup device through the radio link; and receive the operation information that is returned by the backup device through the radio link, or receive an edited object that is returned by the backup device through the radio link, wherein the edited object is obtained by the backup device by editing, according to the operation information, the object corresponding to the object identifier.

An embodiment for the recovery module 36 to send, based on the object identifier, a recovery request to the backup device through the radio link may correspond to the embodiment for the backup module 32 to send, based on the object identifier, the operation information to a backup device through a radio link. For example, the backup module 32 sends the operation information and the object identifier to the backup device through the radio link, and correspondingly, the recovery module 36 may also send the recovery request to the backup device together with the object identifier. For another example, the backup module 32 sends the operation information to the backup device through the transmission channel corresponding to the object identifier, and correspondingly, the recovery module 36 may also send the recovery request to the backup device through the transmission channel corresponding to the object identifier. Any embodiment may be used as long as the backup device can know at which object the recovery request is directed.

Further, the determining module 31 may further record, in response to the editing operation of the user, an operation timestamp of the editing operation, and the backup module 32 sends both the operation information and the operation timestamp to the backup device, or when receiving the operation information, the backup device uses a receiving time as an operation timestamp of the editing operation, and stores the operation timestamp in a manner of corresponding to the operation information. Correspondingly, in an optional embodiment, the recovery request carries a recovery request timestamp; and correspondingly, the recovery module 36 receives operation information, which is returned by the backup device, whose corresponding operation timestamp is later than the recovery request timestamp, or an edited object obtained by the backup device by editing the object corresponding to the object identifier in a time order according to operation information whose corresponding operation timestamp is not later than the recovery request timestamp.

In another optional embodiment, the recovery request does not carry a recovery request timestamp; and correspondingly, the recovery module 36 receives a list of operation information corresponding to the object identifier and returned by the backup device, and the recovery module 36 may select a piece of operation information therein according to an instruction of the user, and receive operation information, which is returned by the backup device, whose corresponding operation timestamp is later than an operation timestamp of the selected operation information, or an edited object obtained by the backup device by editing the object corresponding to the object identifier in a time order according to operation information whose corresponding operation timestamp is not later than the operation timestamp of the selected operation information. The operation timestamp of the selected operation information is equivalent to the recovery request timestamp.

In another optional embodiment, the recovery request may carry a recovery request time period; and correspondingly, the recovery module 36 receives a list of operation information, which is returned by the backup device, whose corresponding operation timestamp is within the time period, and the recovery module 36 may select a piece of operation information therein according to an instruction of the user, and receive operation information, which is returned by the backup device, whose corresponding operation timestamp is later than an operation timestamp of the selected operation information, or an edited object obtained by the backup device by editing the object corresponding to the object identifier in a time order according to operation information whose corresponding operation timestamp is not later than the operation timestamp of the selected operation information. The operation timestamp of the selected operation information is equivalent to the recovery request timestamp.

In the foregoing embodiments, after the operation information returned by the backup device is received, at least one corresponding editing operation may be further canceled based on the current object according to the operation information returned by the backup device, to obtain an object at the recovery request timestamp.

In the foregoing embodiments, in the scenario in which the backup device returns the edited object, the backup device usually stores an object corresponding to the object identifier of a moment before; and correspondingly, that the backup device edits the object in a time order according to operation information whose corresponding operation timestamp is not later than the recovery request timestamp or the operation timestamp of the selected operation information is specifically that: in a time order according to operation information whose corresponding operation timestamp is not earlier than the moment corresponding to the object stored by the backup device and is not later than the recovery request timestamp or the operation timestamp of the selected operation information, the backup device edits the object stored by the backup device.

Alternatively, to save storage space in the backup device, the backup module 32 is further configured to: send, based on the object identifier, a stop backup request to the backup device, wherein the stop backup request is used for instructing the backup device to delete the operation information.

Usually, the stop backup request may be sent by the backup module 32 according to an instruction of the user, or is automatically sent by the backup module 32 when the object of the editing operation is closed. Optionally, the backup device may delete the operation information immediately after receiving the stop backup request, or may not delete the operation information immediately after receiving the stop backup request but store the operation information for a time period before deletion, so that another object could use the operation information. Further, the backup device may further send the operation information to a cloud server, so that the operation information could be directly recovered from the cloud server.

It should be noted that, the operation device 300 may have multiple backup devices, and one backup device may also serve multiple operation devices. The operation device 300 may distinguish different backup devices according to connection related address information, such as an IP address, a physical address, or a link address, and a backup device may distinguish different operation devices by connection related address information.

This embodiment provides a backup operation solution by determining, in response to an editing operation of a user, operation information and an object identifier of the editing operation; and sending, based on the object identifier, the operation information to a backup device through a radio link, and because the at least one transmission parameter of the radio link is set according to the speed of the editing operation, backup transmission power consumption can be controlled through controlling the speed of the editing operation.

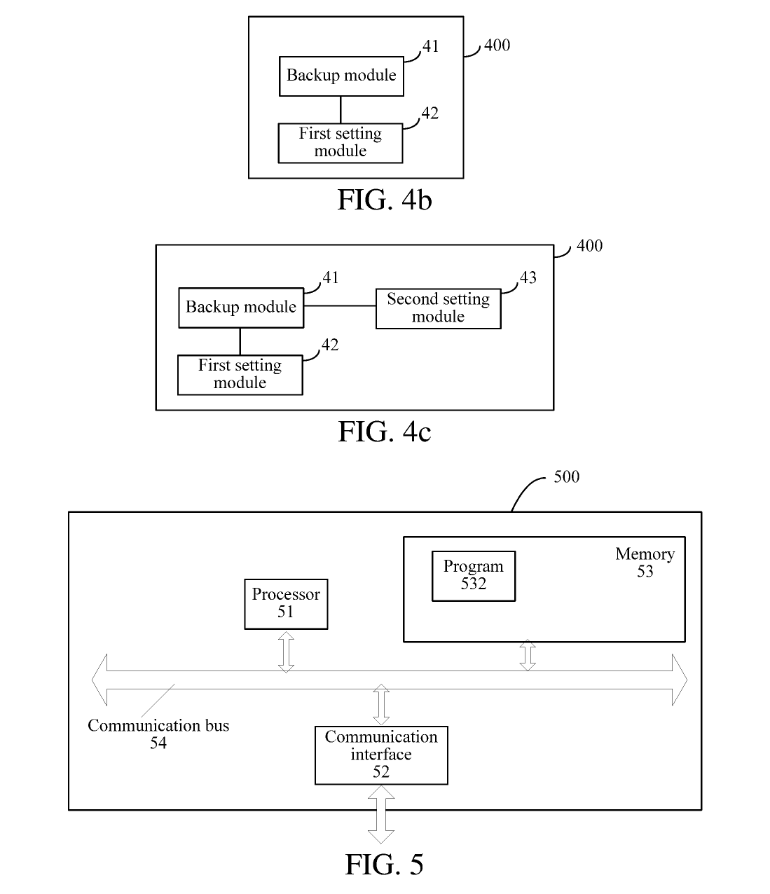

FIG. 4a is a structural diagram of another embodiment of an operation device according to the present application. As shown in FIG. 4a, an operation device 400 comprises:

a backup module 41, configured to back up, in response to an editing operation of a user, an object of the editing operation through a radio link, wherein at least one transmission parameter of the radio link is set according to a speed of the editing operation.

Alternatively, the user performs the editing operation on an object in the operation device 400 by a user interface, such as a keyboard, a mouse, or a touch screen, provided by the operation device 400; and correspondingly, the backup module 41 may determine, by the user interface of the operation device 400, whether a user is performing an editing operation, so as to back up, in response to the editing operation of the user, an object of the editing operation through a radio link. The editing operation may be a single operation, for example, the user taps the keyboard once or clicks the mouse once; or may be continuous multiple operations, which is not limited in this embodiment.

The object of the editing operation may be various editable files, comprising but not limited to: a document, a picture, an audio file, a video file, and the like.

Specifically, the backup module 41 may send, to the backup device through the radio link, an object obtained by editing according to the editing operation.

The radio link may be a link based on any wireless transmission technology, and alternatively, the radio link is a WLAN link. Correspondingly, a different radio link may have at least one different transmission parameter.

The speed of the editing operation may be obtained by counting the number of single operations of the user in a time period.

In an optional embodiment, the radio link is a Bluetooth low energy link, and the at least one transmission parameter comprises: a connection interval and/or a slave latency; and correspondingly, as shown in FIG. 4b, the operation device 400 further comprises: a first setting module 42, configured to: in response to the speed of the editing operation decreases, increase a connection interval and/or slave latency of the Bluetooth low energy link.

Usually, during transmission based on a Bluetooth low energy link, a data sending end is referred to as a master device, a data receiving end is referred to as a slave device, and the master device can set a connection interval and a slave latency.

The connection interval refers to a time interval between starting points of two adjacent connection events, wherein a smaller connection interval usually indicates more timely data transmission, while a larger connection interval usually indicates lower power consumption. Correspondingly, the first setting module 42 may set the connection interval based on the speed of the editing operation, and alternatively, in response to the speed of the editing operation decreases, the first setting module 42 may increase the connection interval of the Bluetooth low energy link, to reduce transmission power consumption. Correspondingly, in response to the speed of the editing operation increases, the first setting module 42 may reduce the connection interval of the Bluetooth low energy link, which is not limited in this embodiment.

The slave latency refers to the maximum number of connection events that the slave device is allowed to ignore, wherein a smaller slave latency usually indicates more timely data transmission, while a larger slave latency usually indicates lower power consumption. Correspondingly, the first setting module 42 may set the slave latency based on the speed of the editing operation, and alternatively, in response to the speed of the editing operation decreases, the first setting module 42 may increase the slave latency of the Bluetooth low energy link, to reduce transmission power consumption. Correspondingly, in response to the speed of the editing operation increases, the first setting module 42 may reduce the slave latency of the Bluetooth low energy link, which is not limited in this embodiment.

In another optional embodiment, the radio link is a WiFi link, and the at least one transmission parameter comprises: a contention-free period repetition interval; and correspondingly, as shown in FIG. 4c, the operation device 400 further comprises: a second setting module 43, configured to: in response to the speed of the editing operation decreases, increase the contention-free period repetition interval of the WiFi link.

In WiFi PCF mode, two ends of data transmission have a contention-free transmission opportunity at regular intervals. A contention-free period repetition interval refers to a time interval between two adjacent contention-free transmission opportunities, and may be set by a data sending end. A smaller contention-free period repetition interval usually indicates more timely data transmission, while a larger contention-free period repetition interval usually indicates lower power consumption. Correspondingly, in response to the speed of the editing operation increases, the second setting module 43 may reduce the contention-free period repetition interval of the WiFi link.

Alternatively, to ensure transmission security in the radio link, the radio link may be further encrypted, for example, a link key is negotiated in a process of establishing the radio link to the backup device, a transmission key is obtained according to the link key, and the backup module 41 sends the object obtained by editing according to the editing operation to the backup device after encrypting the object by the transmission key.

Alternatively, to ensure that the backup device is well prepared, the backup module 41 is further configured to: send a backup request to the backup device through the radio link; and if a backup response of the backup device is received, capture the editing operation of the user. Usually, the backup request may be sent by the backup module 41 according to an instruction of the user, or is automatically sent by the backup module 41 when the object of the editing operation is opened.

Alternatively, to save storage space in the backup device, the backup module 41 is further configured to: send a stop backup request to the backup device, wherein the stop backup request is used for instructing the backup device to delete a backup object.

The stop backup request may carry an object identifier of the object, and the object identifier comprises but not limited to at least one of the following: a process identifier, a file name, and a file handle, wherein the process identifier is an identifier of a process in which the editing operation is located, and the backup device can determine the object of the editing operation by the process identifier; the file name is a file name of the object of the editing operation, and may comprise a main file name and an extended file name, and the backup device can determine the object of the editing operation by the file name; and the file handle is a file handle of the object of the editing operation, the backup device can determine the object of the editing operation by the file handle. Certainly, a combination of any at least two of the process identifier, the file name, and the file handle may also be used as the object identifier, which is not limited in this embodiment.

Usually, the stop backup request may be sent by the backup module 41 according to an instruction of the user, or is automatically sent by the backup module 41 when the object of the editing operation is closed. Optionally, the backup device may delete the operation information immediately after receiving the stop backup request, or may not delete the operation information immediately after receiving the stop backup request but store the operation information for a time period before deletion, so that another object could use the operation information. Further, the backup device may further send the operation information to a cloud server, so that the operation information could be directly recovered from the cloud server.

It should be noted that, the operation device 400 may have multiple backup devices, and one backup device may also serve multiple operation devices. The operation device 400 may distinguish different backup devices according to connection related address information, such as an IP address, a physical address, or a link address, and a backup device may distinguish different operation devices by connection related address information.

This embodiment provides a backup object solution by backing up, in response to an editing operation of a user, an object of the editing operation through a radio link, and because at least one transmission parameter of the radio link is set according to a speed of the editing operation, backup transmission power consumption can be controlled through controlling the speed of the editing operation.

FIG. 5 is a structural diagram of Embodiment 3 of an operation device according to the present application. As shown in FIG. 5, an operation device 500 comprises:

a processor 51, a communication interface 52, a memory 53, and a communication bus 54.

The processor 51, the communication interface 52, and the memory 53 communicate with each other through the communication bus 54.

The communication interface 52 is configured to communicate with an external device such as a backup device.

The processor 51 is configured to execute a program 532, and may specifically execute related steps in the foregoing methods of the various embodiments.

Specifically, the program 532 may comprise program code, wherein the program code comprises a computer operation instruction.

The processor 51 may be a central processing unit (CPU), or an application specific integrated circuit (ASIC), or be configured as one or more integrated circuits for implementing the embodiments of the present application.

The memory 53 is configured to store the program 532. The memory 53 may comprise a high-speed random access memory (RAM), and may further comprise a non-volatile memory, for example, at least one disk memory. In an optional embodiment, the program 532 may be specifically used for enabling the operation device 500 to perform the following steps:

determining, in response to an editing operation of a user, operation information and an object identifier of the editing operation; and

sending, based on the object identifier, the operation information to a backup device through a radio link, wherein at least one transmission parameter of the radio link is set according to a speed of the editing operation.

In another optional embodiment, the program 532 may be specifically used for enabling the operation device 500 to perform the following step:

backing up, in response to an editing operation of a user, an object of the editing operation through a radio link, wherein at least one transmission parameter of the radio link is set according to a speed of the editing operation.

For the specific implementation of the steps in the program 532, reference may be made to corresponding descriptions in the foregoing embodiments of the backup method, and details are not described herein again. It may be clearly understood by a person skilled in the art that, for the purpose of convenient and brief description, for the specific working processes of the foregoing devices and modules, reference may be made to descriptions of corresponding processes in the foregoing Embodiments of the backup method, and details are not described herein again.

Alternatively, the program 532 may be further used for enabling the operation device 500 to choose, according to a set backup mode, whether to perform corresponding steps in a first embodiment of the backup method, or perform corresponding steps in a second embodiment of the backup method. For example, when the backup mode is an operation backup mode, the operation device 500 performs the corresponding steps in the first embodiment of the backup method; and when the backup mode is an object backup mode, the operation device 500 performs the corresponding steps in the second embodiments of the backup method.

A person of ordinary skill in the art may be aware that, in combination with the examples described in the embodiments disclosed in this specification, units and method steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present application.

When the functions are implemented in a form of a software functional unit and sold or used as an independent product, the functions may be stored in a computer readable storage medium. Based on such an understanding, the technical solutions of the present application essentially, or the part contributing to the prior art, or a part of the technical solutions may be implemented in a form of a software product. The computer software product is stored in a storage medium, and comprises several instructions for instructing a computer device (which may be a personal computer, a server, a network device, or the like) to perform all or a part of the steps of the methods described in the embodiments of the present application. The storage medium comprises any medium that can store program code, such as a USB flash drive, a removable hard disk, a read-only memory (ROM), a RAM, a magnetic disk, or an optical disc.

The foregoing embodiments are merely intended to describe the present application rather than limit the present application. A person of ordinary skill in the art may make modifications and variations without departing from the spirit and scope of the present application. Therefore, all equivalent technical solutions shall also fall within the scope of the present application, and the patent protection scope of the present application shall be subject to the claims.

What is claimed is:

1. A method, comprising:
determining, by a device comprising a processor, in response to an editing operation of a user identity, operation information and an object identifier of the editing operation; and
sending, based on the object identifier, the operation information to a backup device via a radio link, wherein a transmission parameter of the radio link is set according to a speed of the editing operation.

2. The method of claim 1, wherein the operation information comprises an operation type and operation content.

3. The method of claim 2, wherein the operation type comprises at least one of a copy type, a paste type, a delete type, an enter type, a cut type, a format edit type, a sort type, a zoom in type, a zoom out type, a rotate type, a distort type, or a clip type.

4. The method of claim 2, wherein the operation information further comprises: an operation position in an object corresponding to the object identifier.

5. The method of claim 1, wherein the object identifier comprises at least one of a process identifier, a file name, or a file handle.

6. The method of claim 1, wherein the radio link is a Bluetooth low energy link, the transmission parameter comprises at least one of a connection interval or a slave latency; and
the method further comprises, in response to the speed of the editing operation being determined to have decreased, increasing at least one of the connection interval or the slave latency of the Bluetooth low energy link.

7. The method of claim 1, wherein the radio link is a WiFi link, the transmission parameter comprises a contention-free period repetition interval; and
the method further comprises, in response to the speed of the editing operation being determined to have decreased, increasing the contention-free period repetition interval of the WiFi link.

8. The method of claim 1, wherein the sending, based on the object identifier, the operation information to the backup device comprises:
sending the operation information and the object identifier to the backup device via the radio link.

9. The method of claim 1, further comprising:
establishing, for the radio link, a transmission channel corresponding to the object identifier,
wherein the sending, based on the object identifier, the operation information to the backup device comprises:
sending the operation information to the backup device via the transmission channel corresponding to the object identifier.

10. The method of claim 1, further comprising:
after the sending, based on the object identifier, the operation information to the backup device, sending, based on the object identifier, a recovery request to the backup device via the radio link; and
receiving the operation information that is returned by the backup device via the radio link, or receiving an edited object that is returned by the backup device via the radio link, wherein the edited object was obtained by the backup device by editing, according to the operation information, the object corresponding to the object identifier.

11. A method, comprising:
backing up, by a device comprising a processor in response to an editing operation of a user identity, an object of the editing operation via a radio link, wherein at least one transmission parameter of the radio link is set according to a speed of the editing operation.

12. The method of claim 11, wherein the radio link is a Bluetooth low energy link, the at least one transmission parameter comprises at least one of a connection interval or a slave latency; and
the method further comprises: in response to the speed of the editing operation being determined to have decreased, increasing at least one of the connection interval or the slave latency of the Bluetooth low energy link.

13. The method of claim 11, wherein the radio link is a WiFi link, and the at least one transmission parameter comprises: a contention-free period repetition interval; and
the method further comprises: in response to the speed of the editing operation being determined to have decreased, increasing the contention-free period repetition interval of the WiFi link.

14. A device, comprising:
a memory that stores executable modules; and
a processor, coupled to the memory, that executes the executable modules to perform operations of the apparatus, the executable modules comprising:
a determining module configured to determine, in response to an editing operation associated with a user identity, operation information and an object identifier of the editing operation; and
a backup module configured to send, based on the object identifier, the operation information to a backup device using a radio link, wherein at least one transmission parameter of the radio link is set according to a speed of the editing operation.

15. The device of claim 14, wherein the operation information comprises an operation type and operation content.

16. The device of claim 15, wherein the operation type comprises at least one of a copy operation type, a paste operation type, a delete operation type, an enter operation type, a cut operation type, a format edit operation type, a sort operation type, a zoom in operation type, a zoom out operation type, a rotate operation type, a distort operation type, or a clip operation type.

17. The device of claim 15, wherein the operation information further comprises: an operation position in an object corresponding to the object identifier.

18. The device of claim 14, wherein the object identifier comprises at least one of a process identifier, a file name, or a file handle.

19. The device of claim 14, wherein the radio link is a Bluetooth low energy link, the at least one transmission parameter comprises at least one of a connection interval or a slave latency; and
the executable modules further comprise: a first setting module configured to: in response to the speed of the editing operation decreasing, increase at least one of the connection interval or the slave latency of the Bluetooth low energy link.

20. The device of claim 14, wherein the radio link is a WiFi link, the at least one transmission parameter comprises: a contention-free period repetition interval; and
the executable modules further comprise: a second setting module configured to: in response to the speed of the editing operation decreasing, increase the contention-free period repetition interval of the WiFi link.

21. The device of claim 14, wherein the backup module is further configured to:
send the operation information and the object identifier to the backup device using the radio link.

22. The device of claim 14, wherein the executable modules further comprise: a channel establishment module configured to establish, using the radio link, a transmission channel corresponding to the object identifier; and
the backup module is further configured to: send the operation information to the backup device via the transmission channel corresponding to the object identifier.

23. The method of claim 14, wherein the executable modules further comprise:
a recovery module configured to send, based on the object identifier, a recovery request to the backup device using the radio link; and receive the operation information that is returned by the backup device using the radio link, or receive an edited object that is returned by the backup device using the radio link, wherein the edited object is obtained by the backup device by editing, according to the operation information, the object corresponding to the object identifier.

24. A device, comprising:
a memory that stores executable modules; and
a processor, coupled to the memory, that executes the executable modules to perform operations of the apparatus, the executable modules comprising:
a backup module configured to back up, in response to an editing operation associated with a user identity, an object of the editing operation via a radio link, wherein a transmission parameter of the radio link is set according to a speed of the editing operation.

25. The device of claim 24, wherein the radio link is a Bluetooth low energy link, the transmission parameter comprises at least one of a connection interval or a slave latency; and
the executable modules further comprise: a first setting module configured to: in response to the speed of the editing operation being determined to have decreased, increase at least one of the connection interval or the slave latency of the Bluetooth low energy link.

26. The device of claim 24, wherein the radio link is a WiFi link, the transmission parameter comprises a contention-free period repetition interval; and
the executable modules further comprise: a second setting module configured to: in response to the speed of the editing operation being determined to have decreased, increase the contention-free period repetition interval of the WiFi link.
